(19) United States
(12) Patent Application Publication
(10) Pub. No.: US 2008/0156153 A1
(43) Pub. Date: Jul. 3, 2008

(54) Gripping Fastener Driver

(76) Inventor: Wade Hampton Nichols, Union Grove, WI (US)

Correspondence Address: JANSSON SHUPE & MUNGER LTD., 245 MAIN STREET, RACINE, WI, 53403, US

(21) Appl. No.: 11/943,189

(22) Filed: Nov. 20, 2007

Related U.S. Application Data
(60) Provisional application No. 60/878,290, filed on Jan. 3, 2007.

(51) Int. Cl. B25B 23/10

(52) U.S. Cl. 81/443

(57) ABSTRACT

In a first embodiment of the present invention a gripping fastener driver includes a primary shaft having a drive end and at least a portion of the shaft is hallow. A drive tip is held in place within the drive end of the primary shaft and a spring is mounted within the primary shaft pressing against the drive tip, whereby the drive tip is biased toward the drive end. A releasable fastener-locking mechanism is attached to the primary shaft and a tightening member movably mounted to the primary shaft. Therefore, tightening member is movable between a first position wherein the locking mechanism is open and a second position wherein the locking mechanism is moved into a closed position.

### RELATED APPLICATIONS

This application claims the benefit of U.S. Provisional Application No. 60/878,290, filed Jan. 3, 2007.

### FIELD OF THE INVENTION

This invention is related generally to handtools and, more particularly, handtools capable of holding a fastener in place during installation.

### BACKGROUND OF THE INVENTION

The basic screwdriver is one of the most common hand tools in use today. In return the most common problem while using such a tool is how to begin the insertion process of a new screw. This problem is further compounded when that installation needs to take place in a tight space. Like any common problem many solutions have been developed such as the use of magnetism or split blade pressure.

For example, U.S. Pat. No. 4,779,494 issued to Quach teaches the use of friction from the unique bit design to hold a screw in place. Two L-shaped portions form the bit and those two portions are in turn moved to hold the screw through the use of a sleeve around the screwdriver.

However, while many different screw-holding screwdrivers exist problems still exist. Magnetic tools cannot be used in many applications, such as around electronics. Friction fit screwdrivers often cannot hold the screw in place if the screw is bumped before or during installation.

### SUMMARY OF THE INVENTION

In a first embodiment of the present invention a gripping fastener driver includes a primary shaft having a drive end and at least a portion of the shaft is hallow. A drive tip is held in place within the drive end of the primary shaft and a spring is mounted within the primary shaft pressing against the drive tip, whereby the drive tip is biased toward the drive end. A releasable fastener-locking mechanism is attached to the primary shaft and a tightening member movably mounted to the primary shaft. Therefore, tightening member is movable between a first position wherein the locking mechanism is open and a second position wherein the locking mechanism is moved into a closed position.

In some embodiments, the tightening member is a secondary shaft movably mounted around the primary shaft. In other embodiments the drive tip is removeably mounted within the drive end of the primary shaft. It is preferred that the drive tip is releasably mounted in the primary shaft via a ball detent mechanism.

In highly preferred embodiments the releasable fastener-locking mechanism includes a plurality of flexible tines. Each of the each tines includes a first portion, the first portion having a mounted end attached to the primary shaft and a free end extending past the primary shaft, and a second portion, the second portion extending from the free end of the first portion and extending substantially perpendicular to the primary shaft. In some embodiments the second portion of the tines includes a first end attached to the free end of the first portion and a second end. It is preferred that the second end is contoured to match a shaft of a fastener. Preferred embodiments of the invention have two or three tines.

In yet another embodiment the gripping fastener driver further includes a compression spring plate between the spring and the drive tip.

In a further embodiments the primary shaft of the gripping fastener driver has a sleeve-locking extension and the secondary shaft has a guide opening disposed to allow movement of the sleeve-locking extension along a length of the guide opening. The secondary shaft then further includes at least one locking opening in communication with the guide opening for receiving the sleeve-locking extension and holding it in place. In preferred embodiments the gripping screwdriver includes a plurality of locking openings. It is highly preferred that the secondary shaft along the guide opening is graduated.

### BRIEF DESCRIPTION OF THE DRAWINGS

FIG. 1 is a side plan view of the shaft of a screwdriver with a preferred embodiment of the present invention.

FIG. 2 is a cut-away view of the primary shaft of FIG. 1.

FIG. 3 is a side plan view of the screwdriver of FIG. 1 with a screw secured thereon.

FIG. 4 is a top plan view of a first embodiment of the tines utilized in conjunction with the screwdriver of FIG. 1.

FIG. 5 is a top plan view of a first embodiment of the tines utilized in conjunction with the screwdriver of FIG. 1.

### DETAILED DESCRIPTION OF THE PREFERRED EMBODIMENTS

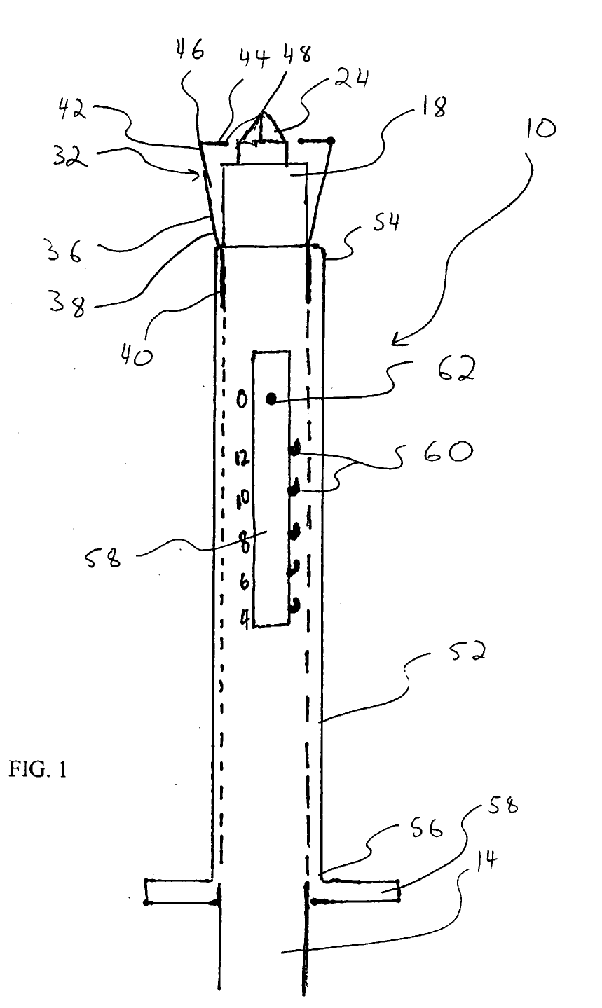

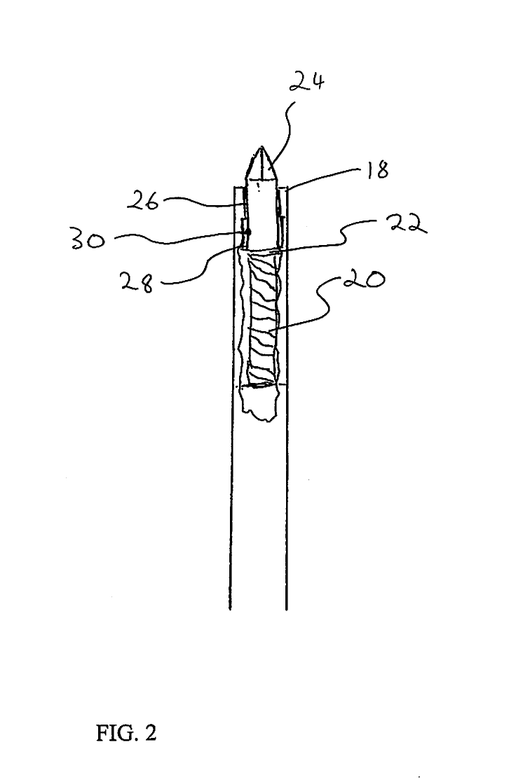

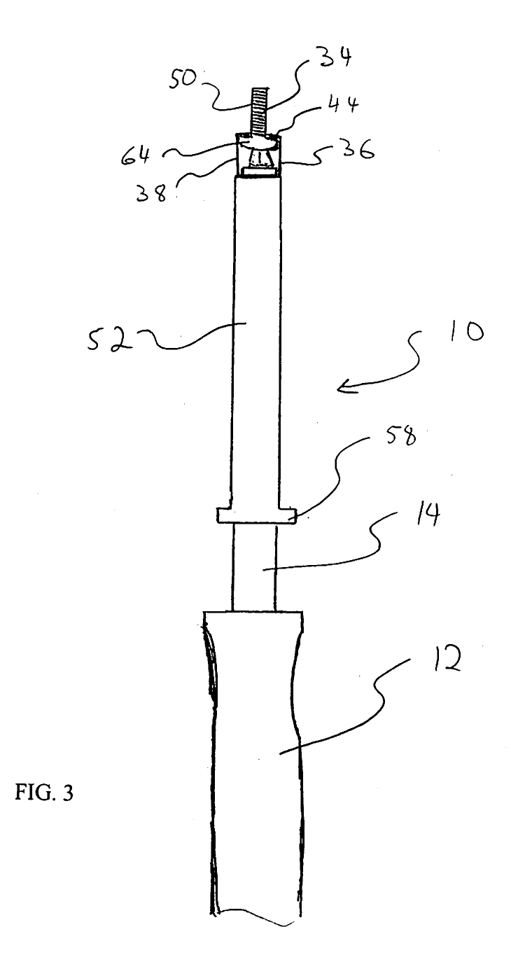

Referring now to FIGS. 1-4 a preferred embodiment of the present inventive gripping fastener screwdriver 10 is shown. The screwdriver 10 includes a grip 12 and a primary shaft 14 attached thereto. The primary shaft 14 is an elongate shaft that includes a grip end 16 attached to the grip 12 and a drive end 18 opposite the grip end 16. The primary shaft 14 is preferably at least partially hollowed out at the drive end 18. As seen best in FIG. 2, the drive end 18 encloses a replaceable tip mechanism. The mechanism includes a spring 20 mounted within the hollow portion of the primary shaft 14. The spring 20 includes a top portion in contact with a compression spring plate 22. The compression spring plate 22 serves to facilitate a continuous connection between the spring 20 and a removable bit 24. The spring 20 serves to bias the bit 24 toward the drive end 18 of the screwdriver 10.

As shown in this preferred embodiment the bit 24 is a phillips head type driver bit; however any known type of bit could be utilized. The portion of the primary shaft 14 that surrounds the bit 24 includes two portions, a first narrow portion 26 just wide enough to allow passage of the bit 24 and a second wide portion 28 to allow a ball-detent mechanism 30 to be disposed within the primary shaft 14 to assist in holding the bit 24 in place.

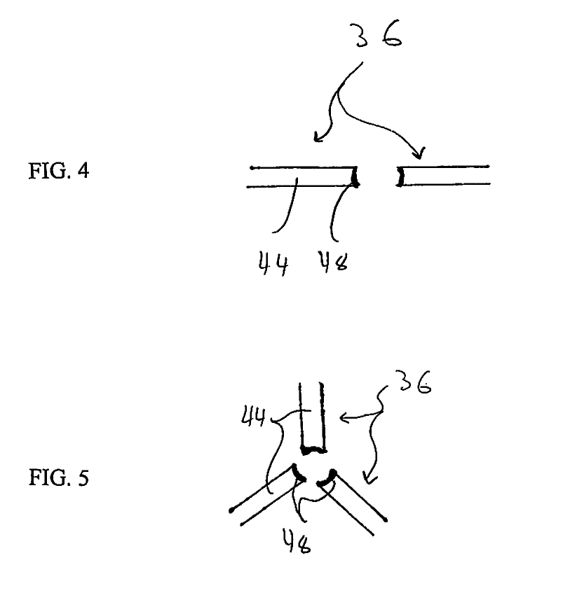

A releasable fastener-locking mechanism 32 extends from the primary shaft 14 and acts to hold a screw 34 on the bit 24. In this preferred embodiment, the releasable fastener-locking mechanism 32 includes a plurality of flexible tines 36 extending from the primary shaft 14 and over the drive end 18. While this preferred embodiment utilizes tines, other faster-locking mechanisms could be utilized such as a complete flexible surround rather then single tines 36. Each tine 36 includes a first portion 38 having a mounted end 40 attached to the primary shaft 14 and a free end 42 extending past the drive end 18 of the primary shaft 14. A second portion 44 extends from the free end 42 and extends substantially perpendicular to the primary shaft 14. A first end 46 of the second portion 44 is attached to the first portion 38 and a second end 48 is free and preferably is contoured to match a shaft 50 of the screw 34. While any number of tines can be utilized it is preferable that two or three tines 26 are utilized and spaced evenly around the primary shaft 14 as shown in FIGS. 4-5.

A tightening member in the form of a secondary shaft 52 surrounds at least a portion of the primary shaft 14. This secondary shaft 52 is slidable on the primary shaft 14 and can serve to tighten the fastener-locking mechanism 32. The secondary shaft 52 includes a first end 54 and a second end 56 opposite the first end 54 and closer to the grip 12. The second end 56 preferably includes an extension 58 perpendicular to the length of the primary shaft 14 for allowing a user to move the secondary shaft 52 between an open position pulled more toward the grip 12 and a closed position pushed toward the drive end 16. In the closed position the first portion 38 of the tines 36 are partially between the primary shaft 14 and the secondary shaft 54, thus compressing the second portion 44 of the tines 36 toward each other.

In this preferred embodiment the secondary shaft 54 defines a guide opening 58 that is graduated for the dimensions of different screw shaft widths. To further increase the accuracy and ease of use, a plurality of locking openings 60 extend from the guide opening 58 and are of dimension to accept a sleeve-locking extension 62 that extends from the primary shaft 14 within the guide opening 58.

In operation, a user places a screw 34 on the bit 24 and presses down, compressing the spring 20. The user then pushes the secondary shaft 54 toward the drive end 18 of the primary shaft 14. This action compresses the tines 36 around the screw 34. When the proper width is reach, preferably, but not necessarily, through use of the graduated markings rather than pressing the tines 36 onto the threaded shaft of the screw 34 the secondary shaft 54 is then turned, causing the sleeve-locking extension 62 to enter one of the locking openings 60 and holding the secondary shaft 54 and thus the screw 34 in place once the screw is released the spring 20 presses the head 64 of the screw 34 against the tines 36. The screw 34 can then be safely secured in whatever setting is necessary. Once the screw 34 is secured, the secondary shaft 54 can be pulled toward the grip 12 thus releasing tension on the tines 36 and allowing the screwdriver 10 to be pulled away.

While the principles of the invention have been shown and described in connection with specific embodiments, it is to be understood that such embodiments are by way of example and are not limiting.

1. A gripping fastener driver comprising:
a primary shaft having a drive end and at least a portion of the shaft being hallow;
a drive tip within the drive end of the primary shaft;
a spring mounted within the primary shaft pressing against the drive tip, whereby the drive tip is biased toward the drive end;
a releasable fastener-locking mechanism attached to the primary shaft; and
a tightening member movably mounted to the primary shaft;
whereby the tightening member is movable between a first position wherein the locking mechanism is open and a second position wherein the locking mechanism is moved into a closed position.

2. The gripping fastener driver of claim 1 wherein the tightening member is a secondary shaft movably mounted around the primary shaft.

3. The gripping fastener driver of claim 2 wherein the drive tip is removeably mounted within the drive end of the primary shaft.

4. The gripping fastener driver of claim 3 wherein the releasable fastener-locking mechanism includes a plurality of flexible tines.

5. The gripping fastener driver of claim 4 wherein each tines include a first portion, the first portion having a mounted end attached to the primary shaft and a free end extending past the primary shaft, and a second portion, the second portion extending from the free end of the first portion and extending substantially perpendicular to the primary shaft.

6. The gripping fastener driver of claim 5 wherein the second portion includes a first end attached to the free end of the first portion and a second end.

7. The gripping fastener driver of claim 6 wherein the second end is contoured to match a shaft of a fastener.

8. The gripping fastener driver of claim 6 having two tines.

9. The gripping fastener driver of claim 6 having three tines.

10. The gripping fastener driver of claim 3 further comprising a compression spring plate between the spring and the drive tip.

11. The gripping fastener driver of claim 10 wherein the drive tip is releasably mounted in the primary shaft via a ball detent mechanism.

12. The gripping fastener driver of claim 2 wherein the primary shaft has a sleeve-locking extension and the secondary shaft has a guide opening disposed to allow movement of the sleeve-locking extension along a length of the guide opening, and wherein the secondary shaft further includes at least one locking opening in communication with the guide opening for receiving the sleeve-locking extension and holding it in place.

13. The gripping fastener driver of claim 12 further including a plurality of locking openings.

14. The gripping fastener driver of claim 13 wherein the secondary shaft along the guide opening is graduated.
